(19) United States
(12) Patent Application Publication
(10) Pub. No.: US 2003/0089273 A1
(43) Pub. Date: May 15, 2003

(54) Europium-ammonium tetra chelates

(76) Inventor: Thomas Potrawa, Seelze (DE)

Correspondence Address: Synnestvedt & Lechner LLP, 2600 Aramark Tower, 1101 Market Street, Philadelphia, PA, 19107-2950, US

(21) Appl. No.: 10/226,833

(22) Filed: Aug. 23, 2002

Related U.S. Application Data
(60) Provisional application No. 60/314,389, filed on Aug. 23, 2001.

(51) Int. Cl. C09D 11/00; C07F 5/00

(52) U.S. Cl. 106/31.15; 252/301.35; 534/15

(57) ABSTRACT

A europium-ammonium tetra chelate compound, composition, and method for making the compound according to the formula NH₄⁺Eu³⁺[X]₄.H₂O, where X is a bidentate ligand is provided. The bidentate ligand may be diketone, and includes thenoyltrifluoroactonate, benzoyltrifluoroacetonate, and napthyltrifluoroacetonate ligands. The compound is invisible under ordinary light conditions, exhibits fluorescence upon exposure to UV light, and is soluble in alcohol and alcohol/water based solutions. The compound may be used as a dye in ink formulations, among other applications.

This application claims the benefit of the filing date for Provisional Application serial No. 60/314,389, filed on Aug. 23, 2001.

### FIELD OF THE INVENTION

The present invention relates generally to dyes, and, more particularly, to europium chelate compounds which exhibit fluorescence upon exposure to UV light, for use in a wide variety of applications, including, but not limited to, dyes in ink compositions.

### BACKGROUND OF THE INVENTION

Fluorescent ink compositions are used as dyes in ink jet printing applications and compositions. An ink jet composition described in U.S. Pat. No. 6,251,175 includes an organic solvent, a colorant, and a hydroxyaromatic resin, for example, hydroxyphenyl. The solvents employed include ethanol and acetone. U.S. Pat. No. 6,251,175 describes the problems associated with the use of methanol and methyl ethyl ketones as solvents in ink jet compositions.

U.S. Pat. No. 5,006,503 describes a fluorescent europium complex which is essentially non-visible under ordinary lighting conditions, but emits a red hue in the region of 610 to 625 nm when irradiated with 360 nm ultraviolet (UV) light. The compound is described as including europium nitrate, thenoyltrifluoroacetone, and tetramethyl ammonium hydroxide (in methanol), which components are dissolved in ethanol.

U.S. Pat. No. 3,562,173 describes laser materials which include rare-earth chelates in a solvent, and an aromatic sensitizer ketone compound.

There remains a need for suitable fluorescent compositions for use as dyes, particularly in ink compositions, that avoids the problems associated with the use of methanol and methyl ethyl ketones as solvents, and that employs a relatively inexpensive and readily available component in formulating the compositions.

### DESCRIPTION OF THE INVENTION AND PREFERRED EMBODIMENTS

A europium chelate compound according to the formula NH₄⁺Eu³⁺[X]₄.H₂O, where X is a bidentate ligand is provided. The compound may also include, as X, a diketone ligand. The diketone ligand (X) may include a thenoyltrifluoroacetonate, benzoyltrifluoroacetonate, or a napthyltrifluoroacetonate ligand. The compound is not visible under ordinary light conditions, but exhibits fluorescence upon exposure to UV light. The compound is soluble in alcohol and alcohol/water based solutions.

An ink composition including a europium chelate compound according to the formula NH₄⁺Eu³⁺[X]₄.H₂O, where X is a bidentate ligand is also provided. The bidentate ligand X also includes a diketone ligand. The diketone ligand may include thenoyltrifluoroacetonate, benzoyltrifluoroacetonate, and napthyltrifluoroacetonate ligands. The compound is not visible under ordinary light conditions, but exhibits fluorescence upon exposure to UV light. The compound is soluble in alcohol and alcohol/water based solutions.

A method is also provided for making a compound according to the formula NH₄⁺Eu³⁺[X]₄.H₂O, where X is a bidentate ligand, which includes providing a chelating agent that includes a bidentate ligand, dissolving the chelating agent in ethanol to form a ligand solution, reacting a europium salt with the ligand solution to form a reaction solution, and adding ammonia to the reaction solution in an amount effective to produce a Europium tetrakis ammonium complex. Where X is a bidentate ligand, X may include a diketone ligand. Diketone ligands may include thenoyltrifluoroacetonate, benzoyltrifluoroacetonate, and napthyltrifluoroacetonate ligands. The compound formed by the method is invisible under ordinary light conditions, but exhibits fluorescence upon exposure to UV light. The molar ratio of the chelating agent to the europium salt is about 3.5:1 to about 5.0:1, and, alternatively, may include a molar ratio of about 3.75:1 to about 4.5:1, or a ratio of 4:1. The molar ratio of ammonia to europium salt is about 3.5:1, and alternatively, may include a molar ratio of ammonia to europium salt of about 4:1.

The present invention provides a family of europium-ammonium tetra chelate compounds described by Formula I, depicted below, where X is a bidentate ligand, which compounds may be used in a wide variety of applications.

Formula I:

NH₄⁺Eu³⁺[X]₄.H₂O (I)

The present invention further provides ink compositions comprising the chelate compounds of the present invention. According to an aspect of the present invention, ink compositions comprising a europium-ammonium tetra chelate composition according to Formula I are provided.

The present invention further provides methods for making the compounds according to Formula 1. According to an aspect of the invention, methods for making the compound comprising a europium-ammonium tetra chelate composition according to Formula 1 are provided.

It has been found that the properties of the compounds according to an aspect of the invention render them particularly well suited for use in colorant or dye compositions such as those used in ink formulations. First, the compounds of Formula I exhibit brilliant fluorescence under ultraviolet (“UV”) light which makes them esthetically pleasing and desirable. The compounds according to an aspect of the invention, which exhibit this fluorescence, are essentially colorless, and hence not visible under ordinary light conditions. This property makes the compounds particularly desirable for use in security applications. Second, the chelate composition dyes of the present invention exhibit increased solubility in ink formulations that are substantially free of methanol and methyl ethyl ketone, which formulations according to an aspect of the invention include ethanol and ethanol/water based solvents. Although not wishing to be bound or limited by any particular theory of operation, it is believed that the use of ammonia to form a central ammonium ion contributes to the increased solubility of the compounds in ethanol and ethanol/water based ink formulations over known compounds, for example, europium complexes including Eu(AA)₃Phen, Na(Eu(AA)₄), Hpip(Eu(AA)₄), Eu(BA)₃Phen, Na(Eu(BA)₄), and other complexes described in Journal of Luminescence, Li, et al., Vol. 40, pp. 235-236 (1988).

As used herein, the well-known term “bidentate” refers generally to a ligand offering two groups of atoms or ions for attachment to the central ion in a chelate composition. Ligands are moieties which enter into a coordination bond with a metal atom, for example, a transition metal atom, or a lanthanide rare earth metal atom, for example, Europium. This may involve charge center development, but not to the extent that the bond is ionic in nature, thus there is considerable covalent character to a ligand/metal bond. Bidentate ligands have two sites on the ligand that form coordination bonds to a metal center which, by virtue of the geometric arrangement of the atoms comprising the ligand, can occupy two coordination sites on a single metal atom simultaneously. It is important to distinguish ligands which have two mono-dentate coordination sites on the ligand from those which have two coordination sites arranged such that they can participate in a bidentate binding interaction. For example, 2,2′ bipyridine is bidentate (the nitrogen atom of each pyridine ring is alpha to the carbon bonded to the other ring) and therefore the nitrogen atoms are geometrically situated such that they can coordinate to two separate coordination sites on a single transition metal atom simultaneously), but 4,4′ bipyridine (the nitrogen atoms of each pyridine ring are gamma to the carbon bonded to the other ring) is not bidentate, because, although each nitrogen atom can coordinate to a separate coordination site on two different transition metals at the same time, they can't both simultaneously coordinate to two different coordination sites on the same transition metal.

By way of example, a thenoyltrifluoroacetonate ligand, which is described by Formula II, below, is a bidentate ligand.

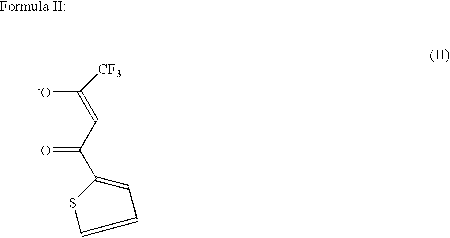

As illustrated by Formula II, the thenoyltrifluoroacetonate ligand offers two oxygen sites for attachment to, or coordination with, a central ion.

As a bidentate ligand, X may be any bidentate ligand capable of coordinating with europium in the presence of ammonia to form a tetra chelate according to Formula I that exhibits fluorescent properties. Examples of bidentate ligands suitable for use in the present invention include those disclosed in U.S. Pat. Nos. 5,006,503 and 3,562,173, and the Journal of Luminescence, Li, et al., Vol. 40, pp. 235-236 (1988), which disclosure of each is hereby incorporated by reference. According to certain preferred embodiments, the bidentate ligands of the present invention which include diketone ligands, include, but are not limited to, thenoyltrifluoroacetonate ligands, benzoyltrifluoroacetonate ligands, and napthyltrifluoroacetonate ligands. In a particularly preferred embodiment, X is a thenoyltrifluoroacetonate ligand.

A variety of methods may be used for preparing the europium-ammonium tetra chelate compounds of the present invention. Methods for preparing various europium chelates are disclosed, for example, in U.S. Pat. No. 5,006,503, U.S. Pat. No. 3,562,173, and Journal of Luminescence, Li, et al., Vol. 40, pp. 235-236 (1988). According to an aspect of the invention, the europium salt, chelating agent, and ammonia of the present invention may be introduced into solution in any order to produce the desired chelate compounds. According to certain preferred embodiments, the chelating agent and europium salt are dissolved into solution prior to the introduction of ammonia.

A preferred method for preparing the chelate compounds according to an aspect of the present invention, includes providing a chelating agent, preferably a bidentate ligand, and dissolving the chelating agent in ethanol to form a ligand solution, with which a europium salt reacts to form a reaction solution. Ammonia is added to the reaction solution in an amount effective to produce the europium-ammonium tetra chelate of Formula I.

Any europium salt capable of reacting with a chelating agent and ammonia to form a tetra chelate compound of Formula I may be used in the method of the present invention. Examples of suitable europium salts are disclosed in U.S. Pat. No. 5,006,503, U.S. Pat. No. 3,562,173, and Journal of Luminescence, Li, et al., vol. 40, pp. 235-236 (1988), and include, but are not limited to the following: europium chloride, europium nitrate, europium acetate, and the like. In certain preferred embodiments, the europium salt used in the present invention is europium chloride.

A wide range of suitable chelating agents may be used in the present invention. As used herein, the term “chelating agent” refers generally to any compound which, when reacted with a europium salt in the presence of ammonia according to an aspect of the present invention, is capable of providing a ligand X as defined above, without inhibiting the formation of a compound of Formula I. Examples of suitable chelating agents are disclosed in U.S. Pat. No. 5,006,503, U.S. Pat. No. 3,562,173, and Journal of Luminescence, Li, et al., Vol. 40, pp. 235-236 (1988), and include compounds, such as, for example, thenoyltrifluoroacetone, benzoyltrifluoroacetone, napthyltrifluoroacetone, and the like. In certain preferred embodiments, the chelating agent is thenoyltrifluoroacetone.

Any commercial grade ammonia may be used in the present invention. Commercial grade ammonia suitable for use in the present invention is available from Sigma Aldrich of Milwaukee, Wis. Ammonia, as opposed to tetramethyl ammonium hydroxide, is relatively inexpensive, is readily available, and particularly suited for use in the present invention.

A wide range of solvents may be used in the production of the present compounds. In particular, any solvent in which both the europium salt and chelating agent are soluble may be used. Examples of suitable solvents include polar solvents, such as, for example, alcohols, including ethanol, n-propanol, isopropanol, and the like; as well as glycols and glycol ethers. In certain preferred embodiments, the solvent is an alcohol. In particularly preferred embodiments, the solvent is ethanol. Methanol is not preferred, as it is toxic.

Any suitable amounts of europium salt and chelating agent may be used in the method of the present invention. Those skilled in the art will appreciate that the amounts of europium salt and chelating agent to be used according to the present invention will depend on many variables, including the particular chelate to be produced and the desired yield from the chelate reaction. For example, in certain embodiments, the molar ratio of chelating agent to europium salt is from about 3.5:1 to about 5.0:1. In more preferred embodiments, the molar ratio of chelating agent to europium salt is from about 3.75:1 to about 4.5:1, and in even more preferred embodiments, about 4:1.

In addition, any suitable amount of ammonia may be used in the method of the present invention. According to certain preferred embodiments, for example, the molar ratio of ammonia to europium salt is at least about 3.5:1. In more preferred embodiments, the molar ratio of ammonia to europium salt is at least about 4:1.

The water used in the present method may be introduced to the reaction substantially simultaneously with any one or more of the europium salt, chelating agent, or ammonia reagents, and/or may be added after all three of such reagents have been dissolved into solution.

The temperature at which the reaction is conducted and the period of reaction will depend in part on the starting materials and amounts used. In view of the present teaching and disclosure, those with skill in the art are capable of adapting the reaction parameters to achieve the particular desired results for numerous starting materials for the desired chelate compounds. In certain preferred embodiments, for example, the temperature of the reaction is from about 0° C. to about 90° C. More preferably, the temperature is from about 0° C. to about 60° C., and even more preferably from about 10° C. to about 35° C.

The compounds of Formula I obtained from the aforementioned reaction may be purified using conventional methods, such as, for example, precipitation, aqueous washes, drying, concentrating under reduced pressure, distillation, and the like.

As noted above, it has been found that the properties of the compounds of Formula I render them particularly well suited for use in colorant or dye compositions such as those used in ink formulations. Accordingly, the chelate compounds of the present invention may be used in a wide range of known ink formulations, including those disclosed in U.S. Pat. Nos. 6,251,175 to Marconi Data Systems, Inc., the entire disclosure of which is hereby incorporated by reference.

In view of the above description, those with skill in the art are capable of producing the compound, and the ink formulations comprising the compound according to an aspect of the invention without undue experimentation. Although the invention has been described with reference to the preferred embodiments thereof, it will be appreciated by those of ordinary skill in the art that modifications may be made to the parts that comprise the invention without departing from the spirit and scope thereof. For example, the compounds may be used as colorants for yarns, fibers, textiles, or used in security, including, for example, the marking of bank checks, envelopes, certificates, and other similar documents, or badges with identification, or for authentication purposes, i.e., counterfeit applications. Other uses include the use of dyes in textiles, for example, yarns and fibers. The following examples serve to further illustrate the invention, but should not be construed as a limitation on the scope thereof, which is defined solely by the appended claims.

### EXAMPLES

In order to further illustrate the present invention in a non-limiting manner, the present invention is described in connection with the following examples, which describe the preparation of Europium tetrakis[4,4,4-trifluoro-1-(2-thienyl)-1,3-butanondionato -0,0′] ammonium complex containing one mole of water according to the Scheme 1, below.

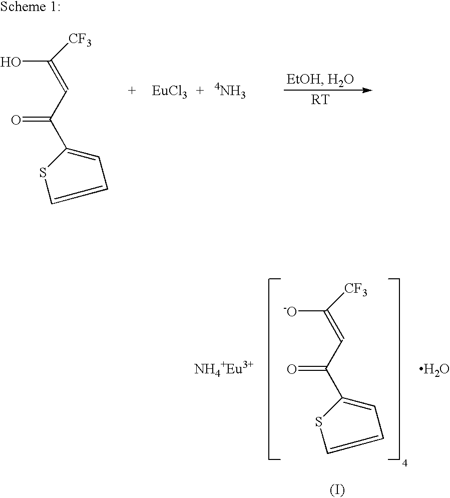

### EXAMPLE 1

To a 100 ml flask containing 40 ml ethanol is added 25.25 grams (114.25 mmol) of thenoyltrifluoroacetone to form a solution. After the thenoyltrifluoroacetone has dissolved completely, an aqueous solution of europium chloride (28.12 mmol) is added to the solution at room temperature. The reaction solution is then filtered to produce a clear solution. To the clear solution is added, under cooling conditions, ammonia (10.38 g) and the resulting solution is stirred overnight. Subsequently, the reaction mixture is filtered, washed with 1 liter of distilled water and dried to produce Europium tetrakis[4,4,4-trifluoro-1-(2-thienyl)-1,3-butanondionato-0,0′] ammonium complex in a yield of greater than 90%.

### EXAMPLE 2

The procedure according to Example 1 is followed, with the thenoyltrifluoroacetone substituted with benzoyltrifluoroacetonate.

### EXAMPLE 3

The procedure according to Example 1 is followed, with the thenoyltrifluoroacetone substituted with napthyltrifluoroacetonate.

Having thus described a few particular embodiments of the invention, various alterations, modifications and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A europium chelate compound comprising the formula:
NH₄⁺Eu³⁺[X]₄.H₂O,
wherein X is a bidentate ligand.

2. The compound according to claim 1 wherein X is a diketone ligand.

3. The compound according to claim 2 wherein X is a thenoyltrifluoroacetonate ligand.

4. The compound according to claim 2, wherein X is a benzoyltrifluoroacetonate ligand.

5. The compound according to claim 2, wherein X is a napthyltrifluoroacetonate ligand.

6. An ink composition comprising a europium chelate compound comprising the formula:
NH₄⁺Eu³⁺[X]₄.H₂O,
wherein X is a bidentate ligand.

7. The composition according to claim 6 wherein X is a diketone ligand.

8. The composition according to claim 7 wherein X is a thenoyltrifluoroacetonate ligand.

9. The composition according to claim 7, wherein X is a benzoyltrifluoroacetonate ligand.

10. The composition according to claim 7, wherein X is a napthyltrifluoroacetonate ligand.

11. The composition according to claim 6, wherein a substrate is coated or impregnated with said composition.

12. A method for making a compound comprising the formula:
NH₄⁺Eu³⁺[X]₄.H₂O,
wherein X is a bidentate ligand, comprising the steps of:
providing a chelating agent comprising a bidentate ligand;
dissolving said chelating agent in ethanol to form a ligand solution;
reacting a europium salt with said ligand solution to form a reaction solution; and,
adding ammonia to said reaction solution in an amount effective to produce a Europium tetrakis ammonium complex according to the formula NH₄⁺Eu³⁺[X]₄.H₂O, wherein X is a bidentate ligand.

13. The method according to claim 12, wherein X is a diketone ligand.

14. The method according to claim 13, wherein X is a thenoyltrifluoroacetonate ligand.

15. The method according to claim 13, wherein X is a benzoyltrifluoroacetonate ligand.

16. The method according to claim 13, wherein X is a napthyltrifluoroacetonate ligand.

17. The method according to claim 12, wherein the molar ratio of said chelating agent to said europium salt is about 3.5:1 to about 5.0:1.

18. The method according to claim 12, wherein the molar ratio of said chelating agent to said europium salt is about 3.75:1 to about 4.5:1.

19. The method according to claim 12, wherein the molar ratio of said chelating agent to said europium salt is about 4:1.

20. The method according to claim 12, wherein the molar ratio of said ammonia to said europium salt is about 3.5:1.

21. The method according to claim 12, wherein the molar ratio of said ammonia to said europium salt is about 4:1.
